(19) United States
(12) Patent Application Publication
(10) Pub. No.: US 2026/0114419 A1
(43) Pub. Date: Apr. 30, 2026

(54) CAT LITTER BOX AND RAMP THEREOF

(71) Applicant: SHENZHEN PETABOO TECHNOLOGY CO., LTD., SHENZHEN (CN)

(72) Inventor: BOCHAO XU, SHENZHEN (CN)

(21) Appl. No.: 19/367,331

(22) Filed: Oct. 23, 2025

(30) Foreign Application Priority Data
Oct. 29, 2024 (CN) 202422619825.3

(51) Int. Cl. A01K 1/01

(52) U.S. Cl. CPC A01K 1/0112

(57) ABSTRACT

A cat litter box and a ramp thereof are provided. The ramp includes a base and a mesh sheet. The mesh sheet and the base are detachable from each other. The base is configured to be disposed at an entrance of a cat litter bin of the cat litter box. The base defines a collecting cavity. The mesh sheet is disposed above the collecting cavity. The base includes at least two base units. The at least two base units are detachably/foldably connected to form the base. The mesh sheet includes at least two unit sheets, and the at least two unit sheets are detachably/foldably connected to form the mesh sheet. A configuration of the ramp effectively reduces a space occupied by the ramp, so that the ramp and the cat litter box are convenient to store and transport.

### TECHNICAL FIELD

The present disclosure relates to a field of pet products, in particular to a cat litter box and a ramp thereof.

### BACKGROUND

Cat litter boxes are a new product that has emerged in recent years. The cat litter boxes are configured to hold cat litter for urination and defecation of cats. In the prior art, a ramp is generally disposed at an entrance of a cat litter box to facilitate a cat to enter and exit the cat litter box. However, the ramp is generally an integrated structure, which takes up a large space and is inconvenient for storing and transporting the cat litter box and the ramp.

### SUMMARY

To solve defects in the prior art, the present disclosure provides a cat litter box and a ramp thereof.

The present disclosure provides a ramp of a cat litter box. The ramp comprises a base and a mesh sheet. The mesh sheet and the base are detachable from each other. The base is configured to be disposed at an entrance of a cat litter bin of the cat litter box. The base defines a collecting cavity. The mesh sheet is disposed above the collecting cavity. The base comprises at least two base units. The at least two base units are detachably/foldably connected to form the base. The mesh sheet comprises at least two unit sheets, and the at least two unit sheets are detachably/foldably connected to form the mesh sheet.

The at least two base units comprise a first base unit and a second base unit, and the first base unit is detachably/ connected to the second base unit.

The first base unit comprises a first side wall. The first side wall of the first base unit faces the second base unit. The first side wall of the first base unit defines snapping grooves. The second base unit comprises a second side wall. The second side wall of the second base unit faces the first base unit. Snapping fasteners are disposed on the second side wall of the second base unit. The first side wall of the first base unit faces the second side wall of the second base unit. The snapping fasteners are snapped in the snapping grooves.

An upper flange and a lower flange are disposed on the first side wall of the first base unit. The upper flange and the lower flange extend toward the second base unit. Positioning blocks are disposed between the upper flange and the lower flange. First positioning grooves are respectively formed between the positioning blocks and the upper flange. Second positioning grooves are respectively formed between the positioning blocks and the lower flange. First plugging blocks and second plugging blocks are disposed on the second side wall of the second base unit. The first plugging blocks and the second plugging blocks extend toward the first side wall of the first base unit. When the snapping fasteners of the second base unit are respectively snapped in the snapping grooves of the first base unit, the first plugging blocks are respectively plugged into the first positioning grooves, and the second plugging blocks are respectively plugged into the second positioning grooves.

The collecting cavity comprises a first sub-cavity and a second sub-cavity. The first sub-cavity is defined in the first base unit. A first opening is defined on one side of the first sub-cavity forming a portion of the first side wall of the first base unit. The second sub-cavity is defined in the second base unit. A second opening is defined on one side of the second sub-cavity forming a portion of the second side wall of the second base unit. When the snapping fasteners of the second base unit are respectively snapped in the snapping grooves of the first base unit, the first opening of the first sub-cavity is communicated with the second opening of the second sub-cavity, so that the first sub-cavity and the second sub-cavity are spliced to form the collecting cavity.

The collecting cavity defines a collecting port. The collecting port comprises a stepped mounting platform. The mesh sheet is placed on the stepped mounting platform, so that the mesh sheet is disposed above the collecting cavity.

The at least two unit sheets comprise a first unit sheet and a second unit sheet, and the first unit sheet is foldably connected to the second unit sheet.

Rotating shafts are disposed on the first unit sheet. Shaft sleeves are disposed on the second unit sheet. The rotating shafts of the first unit sheet are respectively placed in the shaft sleeves of the second unit sheet, so that the first unit sheet is rotatable relative to the second unit sheet to fold the mesh sheet.

A connecting buckle is disposed on a first end of the base. The connecting buckle is configured to be connected to the cat litter bin. Support feet are disposed on a second end of the base. The support feet are detachably connected to a bottom portion of the base.

The present disclosure further provides a cat litter box. The cat litter box comprises the ramp and the cat litter bin described above. The cat litter bin defines the entrance. The ramp is disposed at the entrance of the cat litter bin.

By such configurations, when in use, the ramp is installed at the entrance of the cat litter bin to facilitate entry and exit of a cat. Furthermore, whether the cat enters or exits the cat litter bin, when cat litter or debris is carried by feet of the cat, the cat litter and the debris may fall through the mesh sheet into the collecting cavity for collection. In this way, the debris is prevented from entering the cat litter bin and the cat litter is prevented from being carried out of the cat litter box. The ramp has a simple structure and is easy to use.

Furthermore, when not in use, the base and the mesh sheet are detached from each other. Furthermore, the base comprises the at least two base units that are detachably/foldably connected, allowing the base to be detached/folded. Similarly, the mesh sheet comprises the at least two unit sheets that are detachably/foldably connected, allowing the mesh sheet to be detached/folded. The base and the mesh sheet are allowed to be detached/folded, thereby effectively reducing a space occupied by the ramp and facilitating the storage and transportation of the ramp and the cat litter box having the same.

### BRIEF DESCRIPTION OF DRAWINGS

In order to clearly describe technical solutions in the embodiments of the present disclosure, the following will briefly introduce the drawings that need to be used in the description of the embodiments or the prior art. Apparently, the drawings in the following description are merely some of the embodiments of the present disclosure, and those skilled in the art are able to obtain other drawings according to the drawings without contributing any inventive labor.

The present disclosure is further described below with reference to the accompanying drawings and embodiments.

FIG. 1 is a schematic diagram of a cat little box according to one embodiment of the present disclosure.

FIG. 2 is an exploded schematic diagram of the cat little box shown in FIG. 1.

FIG. 3 is a schematic diagram of a ramp according to one embodiment of the present disclosure.

FIG. 4 is an exploded schematic diagram of the ramp according to one embodiment of the present disclosure.

FIG. 5 is another exploded schematic diagram of the ramp according to one embodiment of the present disclosure.

FIG. 6 is an exploded schematic diagram of a base of the ramp according to one embodiment of the present disclosure.

FIG. 7 is a cross-sectional schematic diagram of the ramp according to one embodiment of the present disclosure.

FIG. 8 is an enlarged schematic diagram of portion A shown in FIG. 7.

FIG. 9 is a cross-sectional schematic diagram of a support foot according to one embodiment of the present disclosure.

FIG. 10 is an exploded schematic diagram of a mesh sheet of the ramp according to one embodiment of the present disclosure.

FIG. 11 is an enlarged schematic diagram of portion B shown in FIG. 10.

### DETAILED DESCRIPTION

### Embodiment 1

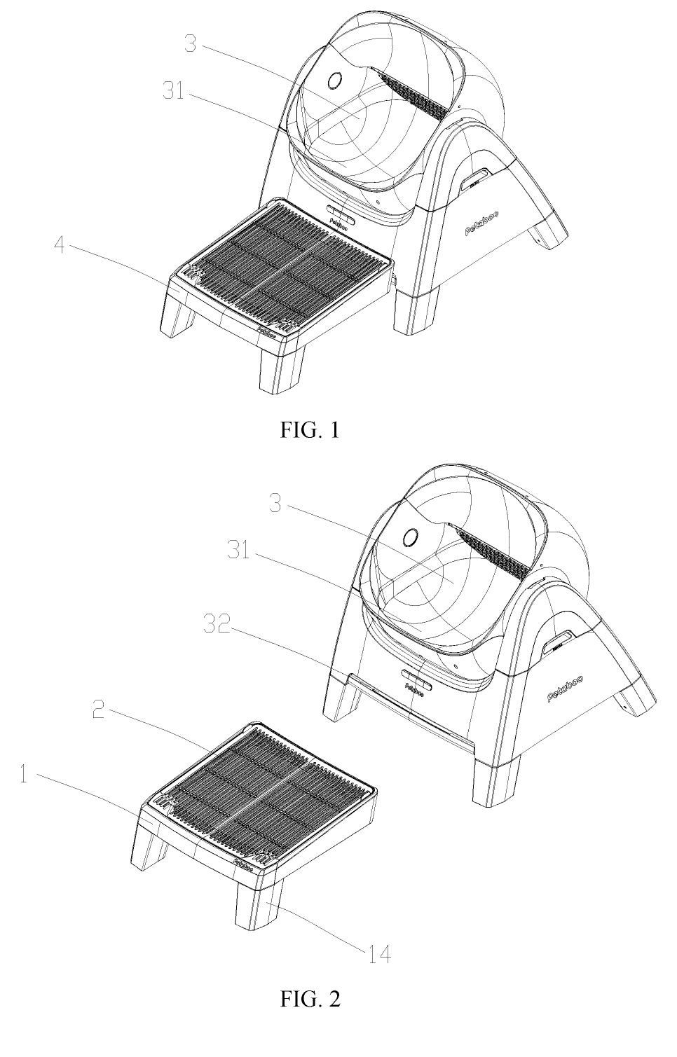

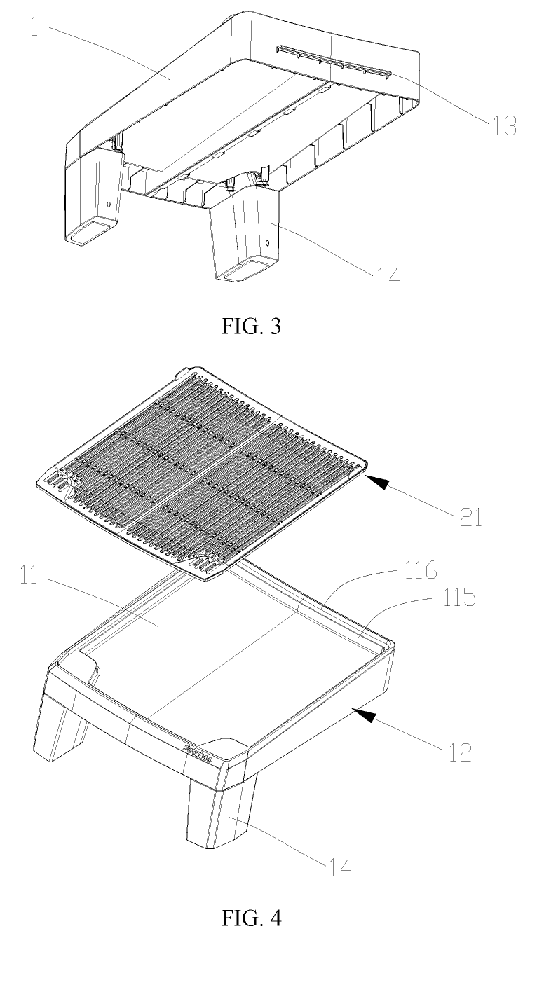

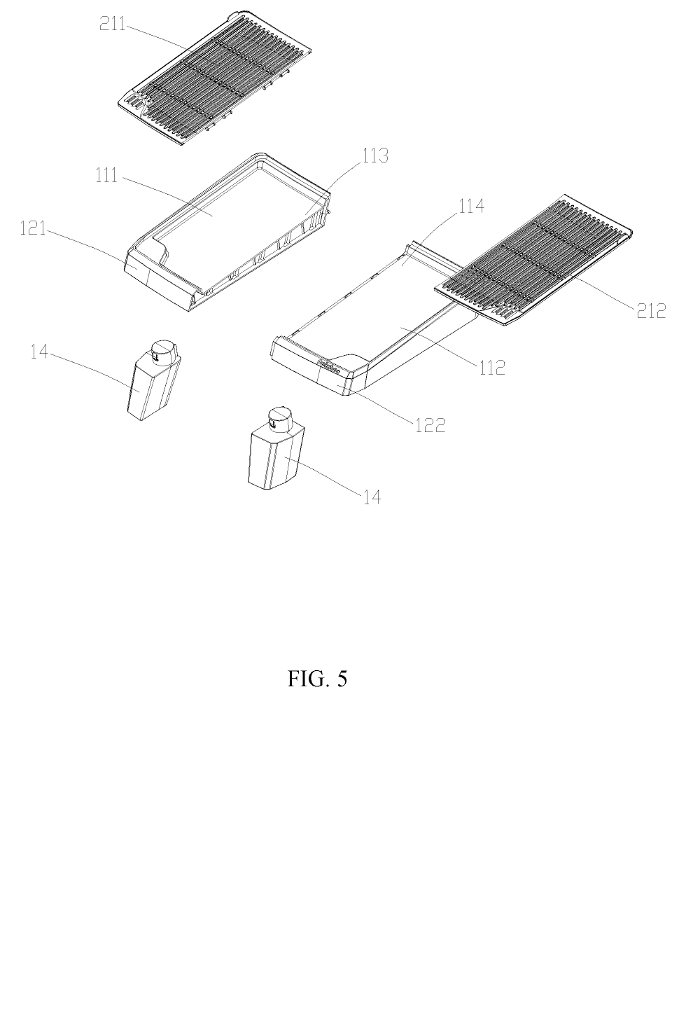

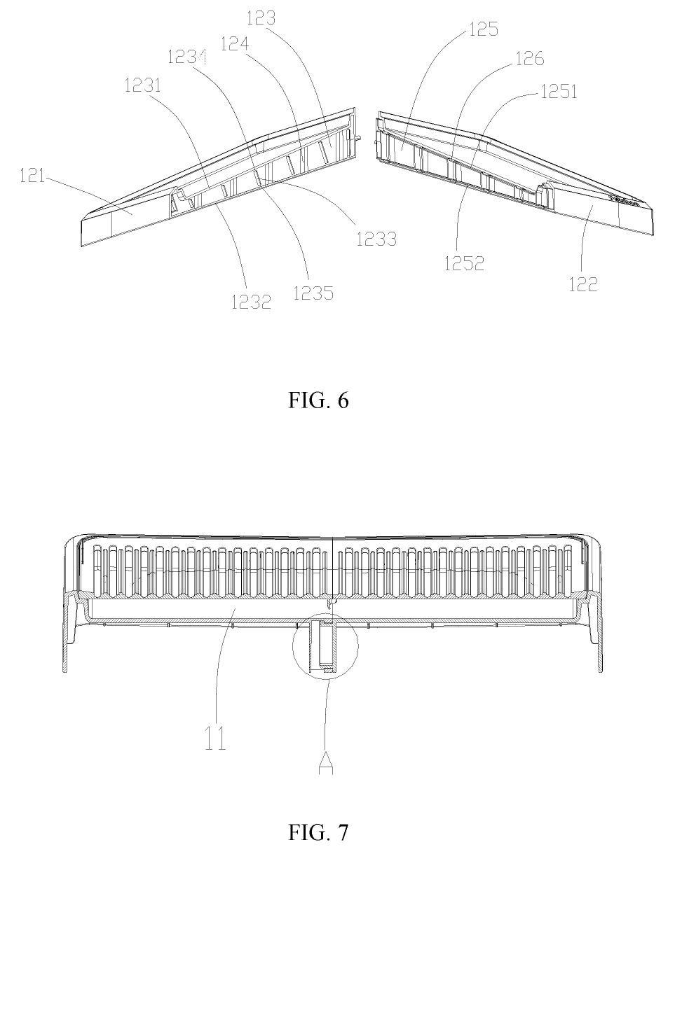

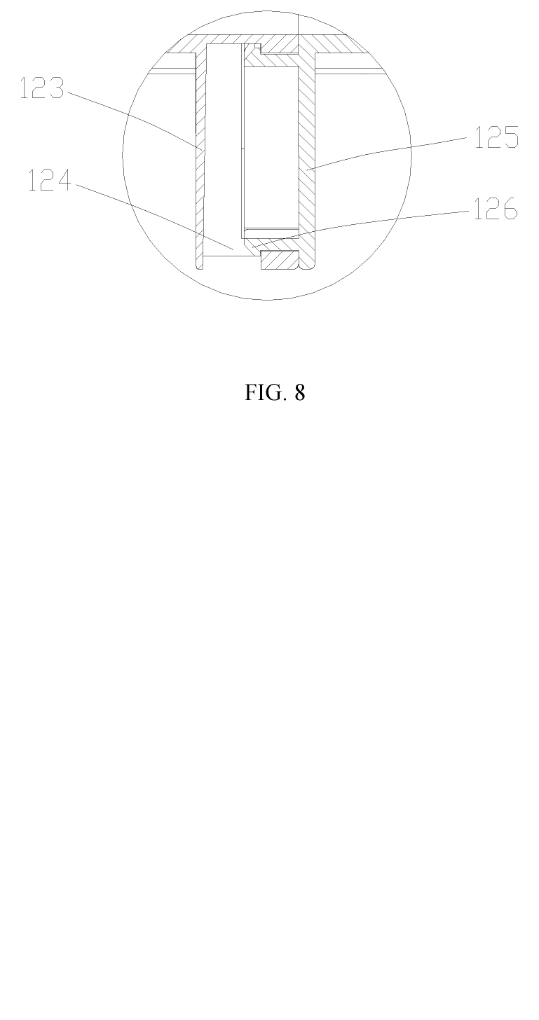

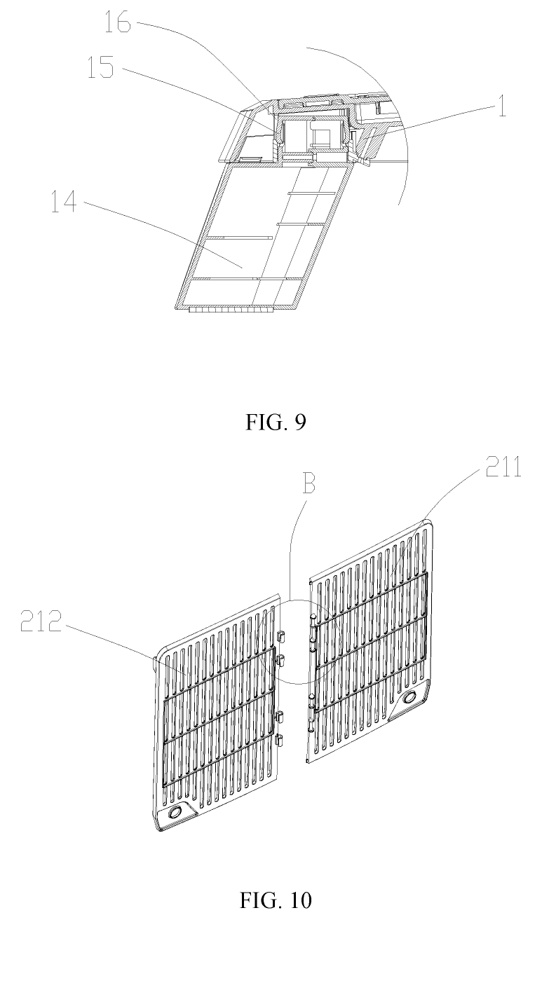

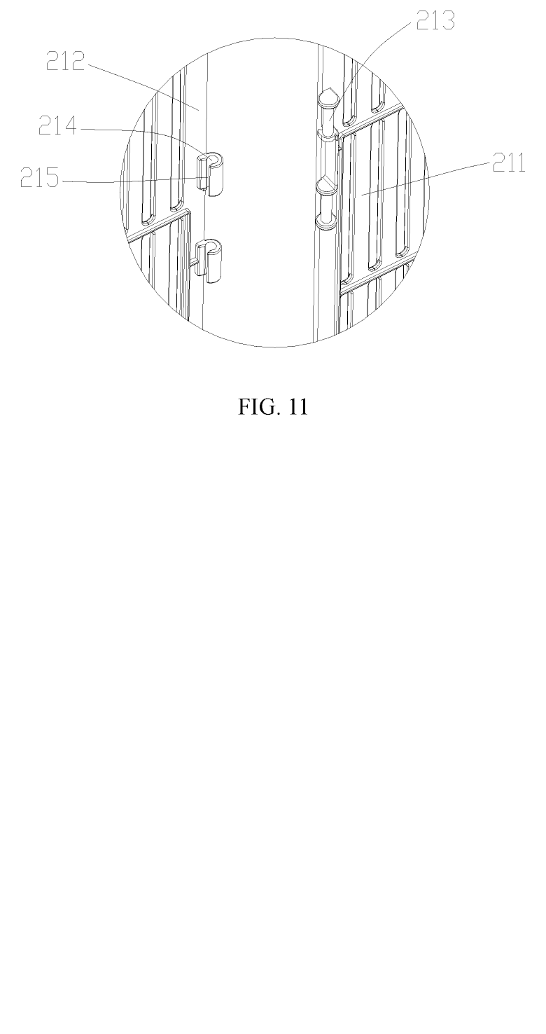

As shown in FIGS. 1-11, the present disclosure provides a ramp of a cat litter box. The ramp comprises a base 1 and a mesh sheet 2. The mesh sheet 2 and the base 1 are detachable from each other. The base 1 is configured to be disposed at an entrance of a cat litter bin of the cat litter box. The base 1 defines a collecting cavity 11. The mesh sheet 2 is disposed above the collecting cavity 11. The base 1 comprises at least two base units 11. The at least two base units 11 are detachably/foldably connected to form the base 1. The mesh sheet 2 comprises at least two unit sheets 21, and the at least two unit sheets 21 are detachably/foldably connected to form the mesh sheet 2.

By such configurations, when in use, the ramp is installed at the entrance of the cat litter bin to facilitate entry and exit of a cat. Furthermore, whether the cat enters or exits the cat litter bin, when cat litter or debris is carried by feet of the cat, the cat litter and the debris may fall through the mesh sheet 2 into the collecting cavity 11 for collection. In this way, the debris is prevented from entering the cat litter bin and the cat litter is prevented from being carried out of the cat litter box. The ramp has a simple structure and is easy to use.

Furthermore, when not in use, the base 1 and the mesh sheet 2 are detached from each other. Furthermore, the base 1 comprises the at least two base units 11 that are detachably/foldably connected, allowing the base 1 to be detached/folded. Similarly, the mesh sheet 2 comprises the at least two unit sheets 21 that are detachably/foldably connected, allowing the mesh sheet 2 to be detached/folded. The base 1 and the mesh sheet 2 are allowed to be detached/folded, thereby effectively reducing the space occupied by the ramp and facilitating the storage and transportation of the ramp and the cat litter box having the same.

In the embodiment, the at least two base units 11 comprise a first base unit 121 and a second base unit 122, and the first base unit 121 is detachably/ connected to the second base unit 122. Of course, the first base unit 121 and the second base unit 122 may be foldably connected. For example, the first base unit 121 and the second base unit 122 may be rotatably folded and stored.

The first base unit 121 comprises a first side wall 123. The first side wall 123 of the first base unit 121 faces the second base unit 122. The first side wall 123 of the first base unit 121 defines snapping grooves 124. The second base unit 122 comprises a second side wall 125. The second side wall 125 of the second base unit 122 faces the first base unit 121. Snapping fasteners 126 are disposed on the second side wall 125 of the second base unit 122. The first side wall 123 of the first base unit 121 faces the second side wall 125 of the second base unit 122. The snapping fasteners 126 are snapped in the snapping grooves 124, so that the first base unit and the second base unit are detachably connected. When disassembling, the snapping fasteners 126 are separated from the snapping grooves 124 to separate the first base unit and the second base unit. A structure of the base is simple and is easy to use. The snapping fasteners are elastic snapping fasteners, making it easier to separate the snapping fasteners 126 from the snapping grooves 124.

Furthermore, an upper flange 1231 and a lower flange 1232 are disposed on the first side wall 123 of the first base unit 121. The upper flange 1231 and the lower flange 1232 extend toward the second base unit 122. Positioning blocks 1233 are disposed between the upper flange 1231 and the lower flange 1232. First positioning grooves 1234 are respectively formed between the positioning blocks 1233 and the upper flange 1231. Second positioning grooves 1235 are respectively formed between the positioning blocks 1233 and the lower flange 1232. First plugging blocks 1251 and second plugging blocks 1252 are disposed on the second side wall 125 of the second base unit 122. The first plugging blocks 1251 and the second plugging blocks 1252 extend toward the first side wall 123 of the first base unit 121. When the snapping fasteners 126 of the second base unit 122 are respectively snapped in the snapping grooves 124 of the first base unit 121, the first plugging blocks 1251are respectively plugged into the first positioning grooves 1234, and the second plugging blocks 1252 are respectively plugged into the second positioning grooves 1235. In this way, an assembly and connection between the first base unit and the second base unit is very convenient. The positioning blocks are disposed side by side along the first side wall of the first base unit to form the first positioning grooves and the second positioning grooves. Accordingly, the number of the first plugging blocks and the second plugging blocks corresponds to the number of the positioning grooves.

In the embodiment, the collecting cavity 11 comprises a first sub-cavity 111 and a second sub-cavity 112. The first sub-cavity 111 is defined in the first base unit 121. A first opening 113 is defined on one side of the first sub-cavity 111 forming a portion of the first side wall 123 of the first base unit 121. The second sub-cavity 112 is defined in the second base unit 122. A second opening 114 is defined on one side of the second sub-cavity 112 forming a portion of the second side wall 125 of the second base unit 122. When the snapping fasteners 126 of the second base unit 122 are respectively snapped in the snapping grooves 124 of the first base unit 121, the first opening 113 of the first sub-cavity 111 is communicated with the second opening 114 of the second sub-cavity 112, so that the first sub-cavity 111 and the second sub-cavity 112 are spliced to form the collecting cavity 11. A structure of the collecting cavity 11 is simple and is easy to assemble.

In the embodiment, the collecting cavity 11 defines a collecting port 115. The collecting port 115 comprises a stepped mounting platform 116. The mesh sheet 2 is placed on the stepped mounting platform 116, so that the mesh sheet 2 is disposed above the collecting cavity 11. A configuration of the collecting cavity 11 facilitates a mutual detachment of the mesh sheet and the base, and the structure thereof is simple and easy to use.

In the embodiment, the at least two unit sheets 21 comprise a first unit sheet 211 and a second unit sheet 212, and the first unit sheet 211 is foldably connected to the second unit sheet 212. Of course, the first unit sheet and the second unit sheet may be detachably connected. For example, the first unit sheet and the second unit sheet may be detachably connected by being fastened to each other.

Rotating shafts 213 are disposed on the first unit sheet 211. Shaft sleeves 214 are disposed on the second unit sheet 212. The rotating shafts 213 of the first unit sheet 211 are respectively placed in the shaft sleeves 214 of the second unit sheet 212, so that the first unit sheet 211 is rotatable relative to the second unit sheet 212 to fold the mesh sheet 2. The mesh sheet has a simple structure and is easy to store. Furthermore, each of the shaft sleeves comprises a holding opening 215 on a sidewall thereof. A width of each holding opening is less than a diameter of each of the rotating shafts. The shaft sleeves are made of plastic, which allows each of the rotating shafts to be extruded into a corresponding one of the shaft sleeves through a corresponding holding opening, leading to a simple structure and easy assembly. Both the first unit sheet and the second unit sheet are made of plastic.

In the embodiment, a connecting buckle 13 is disposed on a first end of the base 1, and the connecting buckle 13 is configured to be connected to the cat litter bin. Support feet 14 are disposed on a second end of the base 1. The support feet 14 are detachably connected to a bottom portion of the base 1.

Specifically, a connecting groove 32 is defined at the entrance of the cat litter bin. The first end of the base body is fastened to the connecting groove of the cat litter bin through the connecting buckle 13. Furthermore, the support feet are disposed at the second end of the base 1, ensuring a stable placement of the base (ramp). The structure of the ramp is simple and is convenient to use.

Furthermore, the support feet are detachable and are able to be removed and stored when not in use, thereby reducing space usage. The support feet are connected to the bottom portion of the base by elastic fasteners 15. The elastic fasteners are respectively engaged with mounting grooves 16, to realize assembly and disassembly of the support feet, which is convenient to operate.

### Embodiment 2

As shown in FIGS. 1-11, the present disclosure further provides a cat litter box. The cat litter box comprises the ramp 4 and the cat litter bin 3 described above. The cat litter bin 3 defines the entrance 31. The ramp 4 is disposed at the entrance of the cat litter bin.

By such configurations, when in use, the ramp is installed at the entrance 31 of the cat litter bin 3 to facilitate entry and exit of the cat. Furthermore, whether the cat enters or exits the cat litter bin 3, when cat litter or debris is carried by the feet of the cat, the cat litter and the debris may fall through the mesh sheet 2 into the collecting cavity 11 for collection. In this way, the debris is prevented from entering the cat litter bin and the cat litter is prevented from being carried out of the cat litter bin. The ramp has a simple structure and is easy to use.

Furthermore, when not in use, the base 1 and the mesh sheet 2 are detached from each other. Furthermore, the base 1 comprises the at least two base units 11 that are detachably/foldably connected, allowing the base 1 to be detached/folded. Similarly, the mesh sheet 2 comprises the at least two unit sheets 21 that are detachably/foldably connected, allowing the mesh sheet 2 to be detached/folded. The base 1 and the mesh sheet 2 are allowed to be detached/folded, thereby effectively reducing the space occupied by the ramp and facilitating the storage and transportation of the ramp and the cat litter box having the same.

The above descriptions provide one or more embodiments in conjunction with the specific content, and specific implementations of the present disclosure are not limited thereto. Any similarity or similarity with the methods, structures, etc. of the present disclosure, or any technical deduction or substitution based on the concept of the present disclosure, shall be deemed to be within the protection scope of the present disclosure.

What is claimed is:

1. A ramp of a cat litter box, comprising:
a base; and
a mesh sheet;
wherein the mesh sheet and the base are detachable from each other, and the base is configured to be disposed at an entrance of a cat litter bin of the cat litter box;
wherein the base defines a collecting cavity, the mesh sheet is disposed above the collecting cavity, the base comprises at least two base units, and the at least two base units are detachably/foldably connected to form the base;
wherein the mesh sheet comprises at least two unit sheets, and the at least two unit sheets are detachably/foldably connected to form the mesh sheet.

2. The ramp according to claim 1, wherein the at least two base units comprise a first base unit and a second base unit, and the first base unit is detachably/ connected to the second base unit.

3. The ramp according to claim 2, wherein the first base unit comprises a first side wall, the first side wall of the first base unit faces the second base unit, and the first side wall of the first base unit defines snapping grooves;
wherein the second base unit comprises a second side wall, the second side wall of the second base unit faces the first base unit, and snapping fasteners are disposed on the second side wall of the second base unit;
wherein the first side wall of the first base unit faces the second side wall of the second base unit, and the snapping fasteners are respectively snapped in the snapping grooves.

4. The ramp according to claim 3, wherein an upper flange and a lower flange are disposed on the first side wall of the first base unit, the upper flange and the lower flange extend toward the second base unit, and positioning blocks are disposed between the upper flange and the lower flange;
wherein first positioning grooves are respectively formed between the positioning blocks and the upper flange, and second positioning grooves are respectively formed between the positioning blocks and the lower flange;
wherein first plugging blocks and second plugging blocks are disposed on the second side wall of the second base unit, and the first plugging blocks and the second plugging blocks extend toward the first side wall of the first base unit;
wherein when the snapping fasteners of the second base unit are respectively snapped in the snapping grooves of the first base unit, the first plugging blocks are respectively plugged into the first positioning grooves, and the second plugging blocks are respectively plugged into the second positioning grooves.

5. The ramp according to claim 3, wherein the collecting cavity comprises a first sub-cavity and a second sub-cavity, the first sub-cavity is defined in the first base unit, a first opening is defined on one side of the first sub-cavity forming a portion of the first side wall of the first base unit, the second sub-cavity is defined in the second base unit, and a second opening is defined on one side of the second sub-cavity forming a portion of the second side wall of the second base unit;
wherein when the snapping fasteners of the second base unit are respectively snapped in the snapping grooves of the first base unit, the first opening of the first sub-cavity is communicated with the second opening of the second sub-cavity, so that the first sub-cavity and the second sub-cavity are spliced to form the collecting cavity.

6. The ramp according to claim 1, wherein the collecting cavity defines a collecting port, the collecting port comprises a stepped mounting platform, and the mesh sheet is placed on the stepped mounting platform, so that the mesh sheet is disposed above the collecting cavity.

7. The ramp according to claim 1, wherein the at least two unit sheets comprise a first unit sheet and a second unit sheet, and the first unit sheet is foldably connected to the second unit sheet.

8. The ramp according to claim 7, wherein rotating shafts are disposed on the first unit sheet, shaft sleeves are disposed on the second unit sheet, and the rotating shafts of the first unit sheet are respectively placed in the shaft sleeves of the second unit sheet, so that the first unit sheet is rotatable relative to the second unit sheet to fold the mesh sheet.

9. The ramp according to claim 1, wherein a connecting buckle is disposed on a first end of the base, the connecting buckle is configured to be connected to the cat litter bin, support feet are disposed on a second end of the base, and the support feet are detachably connected to a bottom portion of the base.

10. A cat little box, comprising:
the ramp according to claim 1; and
the cat litter bin;
wherein the cat litter bin defines the entrance, and the ramp is disposed at the entrance of the cat litter bin.
